(19) United States
(12) Patent Application Publication
(10) Pub. No.: US 2011/0186488 A1
(43) Pub. Date: Aug. 4, 2011

(54) Document Stacking Module

(75) Inventor: Anders Bengt Verner Nordin, Katrineholm (SE)

(73) Assignee: De La Rue Cash Systems AB, Flen (SE)

(21) Appl. No.: 12/599,347

(22) PCT Filed: May 11, 2007
(86) PCT No.: PCT/EP07/04180

§ 371 Date: Jan. 11, 2010

(51) Int. Cl. B07C 5/38; B07C 5/00; B65H 29/62; B65H 29/40

(52) U.S. Cl. 209/534; 209/552; 271/307; 271/279

(57) ABSTRACT

A document stacking module comprises a rotatably mounted stacking wheel (10) having at least one generally radially outwardly extending slot (14-16) which can be aligned with a document delivery position so as to receive a document. The wheel (10) is rotatable to a stacking position where the wheel cooperates with a stripper member (19) to extract a document from the slot whereby the document is stacked at the stacking position. A motor rotates the stacking wheel (10). A control system controls operation of the motor. The outer surface of part (22) of the stacking wheel (10) is shaped so that, when said part is presented to the document delivery position, the document fed through the document delivery position towards the stacking wheel engages the shaped part of the outer surface of the stacking wheel and is diverted away from the stacking wheel.

The invention relates to a document stacking module, for example for use in document handling apparatus such as apparatus for handling documents of value including banknotes.

In conventional document dispensers, sorters and recyclers, documents are transported along a transport path where they are subjected to various monitoring processes, for example to check that the documents are being fed singly, that they are fit, authentic and sometimes also to determine denomination in the case of banknotes. Once the tests have been made, the document has to be routed to a suitable location and this is done by means of a diverter element in the transport path which is set to be activated to divert certain documents from passing along one part of the path into another part. In addition, conventional document handling apparatus for dispensing, receiving and sorting documents includes one or more stacking positions in which the documents are stacked. In order to stack the documents neatly and compactly, it is common to make use of a rotatably mounted stacking wheel having at least one generally radially outwardly extending slot which can be aligned with a document delivery position so as to receive a document, the wheel being rotatable to a stacking position where the wheel cooperates with a stripper member to extract the document from the slot whereby the document is stacked at the stacking position.

There is a continuing need to develop more compact document handling apparatus and a more simply constructed apparatus, particularly for implementing desktop devices and the like.

In accordance with a first aspect of the present invention, a document stacking module comprises a rotatably mounted stacking wheel having at least one generally radially outwardly extending slot which can be aligned with a document delivery position so as to receive a document, the wheel being rotatable to a stacking position where the wheel cooperates with a stripper member to extract a document from the slot whereby the document is stacked at the stacking position; a motor for rotating the stacking wheel; and a control system for controlling operation of the motor characterised in that the outer surface of a first part of the stacking wheel is shaped so that, when said first part is presented to the document delivery position, the document fed through the document delivery position towards the stacking wheel engages the first shaped part of the outer surface of the stacking wheel and is diverted away from the stacking wheel in a first direction.

In accordance with a second aspect of the present invention, a method of operating a document stacking module comprising a rotatably mounted stacking wheel having at least one generally radially outwardly extending slot which can be aligned with a document delivery position so as to receive a document, the wheel being rotatable to a stacking position where the wheel cooperates with a stripper member to extract a document from the slot whereby the document is stacked at the stacking position, the outer surface of a first part of the stacking wheel being shaped so that, when said first part is presented to the document delivery position, a document delivered towards the stacking wheel is diverted away from the stacking wheel, the method comprising selectively rotating the stacking wheel to present either the document receiving slot or the shaped outer surface first part of the stacking wheel to the document delivery position.

We have developed a completely new document stacking module in which a stacking wheel and diverter are combined together into one unit. It will readily be seen that this results in a much more compact arrangement thus reducing the space required and leading to the ability to construct desktop systems. A single motor is required both for the diverting function and the stacking function and there is an overall reduction in the number of mechanical parts, a reduced amount of control software, less use of electrical power and a lower product and manufacturing cost.

Although a stacking wheel with a single document receiving slot could be used, typically, the stacking wheel will have two, three or more document receiving slots. These slots will be generally equally circumferentially spaced around the stacking wheel.

A single stacking wheel could be provided or alternatively two or more coaxially arranged with their slots in alignment. In a further alternative the stacking wheel could be formed by a cylinder.

In a similar way, a single shaped outer surface part could be provided but typically two or more such parts will be provided to reduce operation time.

The or each shaped outer surface part preferably presents a concave shape to a document delivery position.

Where the stacking wheel comprises at least one tine defining a wall of the document receiving slot, the radially outwardly facing surface of the tine can be formed in a concave shape.

Typically, a second stacking position or a reject position is located so as to receive documents diverted by the stacking wheel although in other arrangements the documents could be diverted into another transport path.

Typically, the motor would be controlled to return the stacking wheel to a datum position or one of a number of datum positions after each document has been stacked or diverted. This datum position will typically be where the or one of the document receiving slots is aligned with the document delivery position.

Some examples of document stacking modules according to the invention will now be described with reference to the accompanying drawings, in which:—

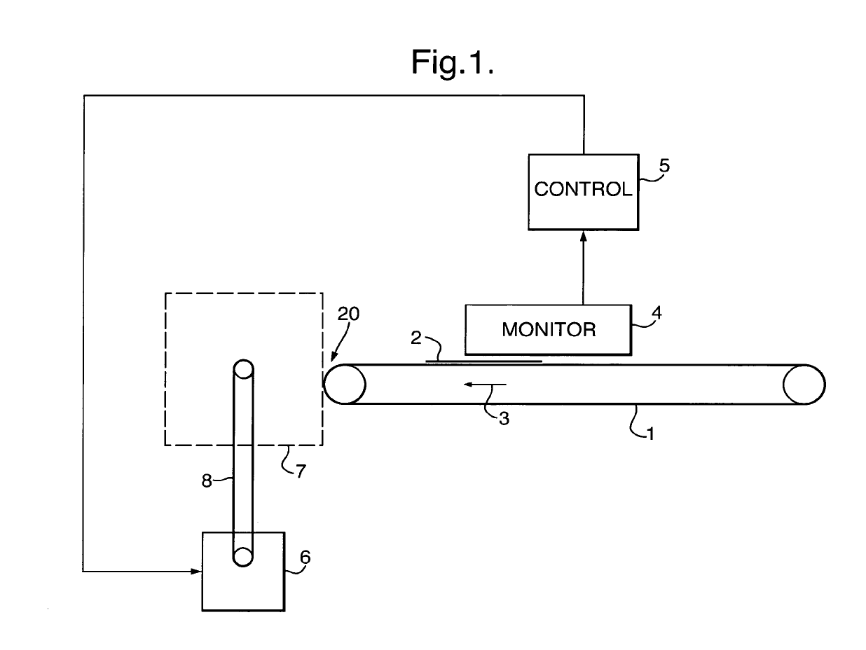

FIG. 1 is a schematic view of a document handling apparatus, specifically for handling banknotes;

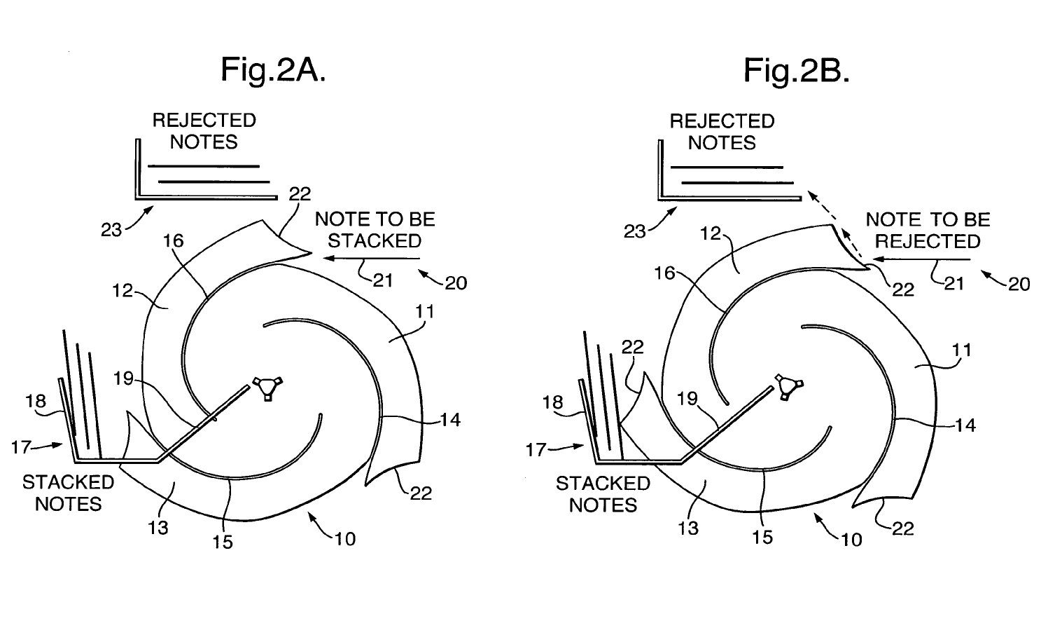

FIGS. 2A and 2B illustrate a first example of a document stacking module with a stacking wheel in a note receiving and a note diverting position respectively;

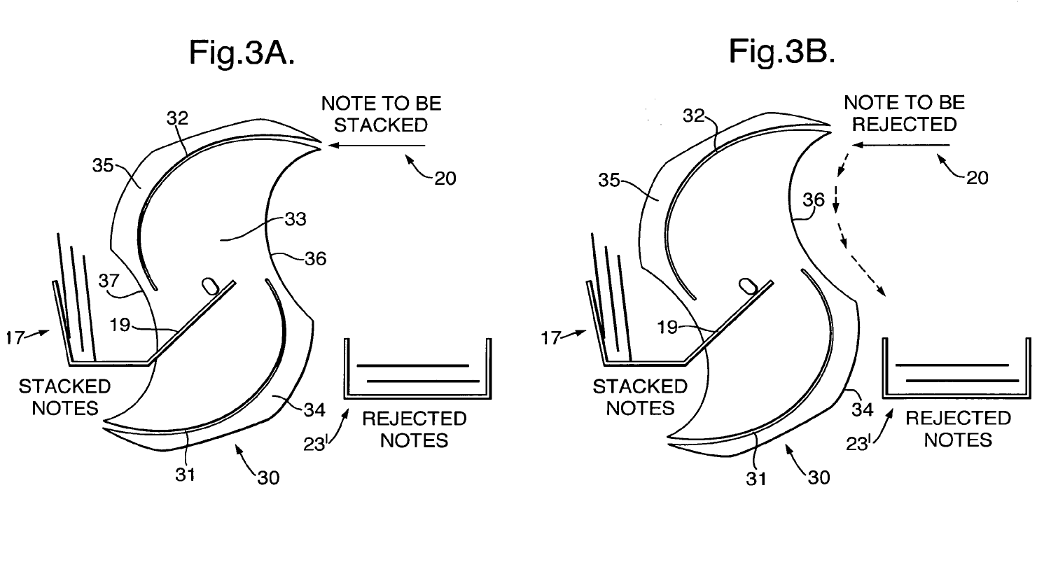

FIGS. 3A and 3B are views similar to FIGS. 2A and 2B respectively but of a second example; and,

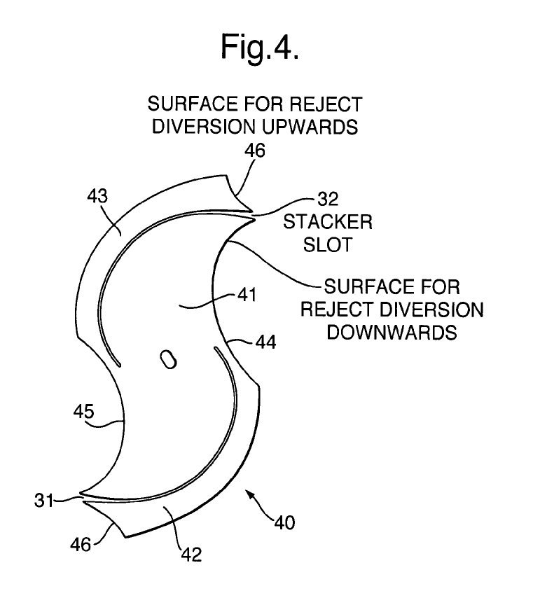

FIG. 4 illustrates a third example of a stacking wheel.

The apparatus shown in FIG. 1 is very schematically indicated but intended to show an example of the location of a stacking module according to the invention. The apparatus comprises a transport belt 1 which is rotated in use by a motor (not shown) to transport banknotes 2 in a direction 3. The banknotes pass under a monitoring system 4 of conventional structure which can be adapted to determine one or more of the condition or fitness, denomination and authenticity of each banknote. Information from the monitoring system 4 is fed to a control system 5 such as a suitably programmed computer. The control system 5 controls operation of a stepper motor 6 coupled with a stacking wheel of the stacking module 7 via a drive belt 8.

As will be readily understood, the apparatus shown in FIG. 1 could form part of a banknote sorting apparatus, a banknote dispenser or a banknote recycler or the like. In general, where the stacking module 7 provides two possible destinations for banknotes, the system shown in FIG. 1 could be used to extract documents with a particular characteristic, such as a particular quality, denomination, orientation, authenticity or the like and feed these to a first stack while all other documents not having that characteristic are fed to a second stack or reject position. In another example, if banknotes of two denominations are supplied to the system then the system can be used to sort the banknotes into the two denominations. FIG. 2 illustrates a first example of a stacking module according to the invention. As can be seen in FIG. 2A, a stacking module includes a rotatably mounted stacking wheel 10, the wheel 10 having three spiral tines 11-13 which define three banknote receiving slots 14-16 equally circumferentially spaced around the wheel.

A first stacking position 17 is provided to the left of the stacking wheel 10 and comprises an output hopper 18 and a stripper plate 19 which extends alongside and radially inwardly of the stacking wheel 10.

The stacking of banknotes in the hopper 18 is conventional. Thus, initially, before a document has arrived at the stacking module at a banknote delivery position 20, the control system 5 operates the stepper motor 6 to position the stacking wheel 10 such that the opening into the slot 16 faces the banknote delivery position 20. The banknote is then delivered into the slot 16 by the transport system as indicated by an arrow 21. When the document has been partially or fully delivered into the slot 16, the control system 5 operates the stepper motor 6 to rotate the stacking wheel 10 in an anti-clockwise direction. As the leading end of the banknote engages the stripper plate 19, it will be pushed out of the slot 16 and drop into the hopper 18. The wheel 10 is further rotated to bring the next slot 14 into alignment with the banknote delivery position 20.

If the control system 5 determines from the information delivered by the monitoring system 4 that the banknote 2 should not be supplied to the first stacking position 17 then, before the banknote 2 exits from the banknote delivery position 20, the control system 5 causes the stepper motor 6 to rotate the stacking wheel 10 a small amount in a clockwise direction so as to bring a concave shaped surface 22 of the tine 12 into alignment with the banknote delivery position 20 (FIG. 2B). The wheel 10 is maintained stationary and the banknote 2 will engage the concave surface 22 of the tine 12 and be diverted up into a reject stacking position 23.

It will be noted that each of the tines 12,13 or 14 has a similar concave outwardly facing surface 22.

After the banknote 2 has been successfully diverted into the reject stacking position 23, the control system 5 causes the stepper motor 6 to rotate the wheel 10 a small amount anti-clockwise to bring the slot 16 back to a datum position in alignment with the banknote delivery position 20 as shown in FIG. 2A.

In the example just described, the stepper motor 6 is operated to rotate the wheel 10 to bring the slot 16 back to the datum position after each banknote has been processed. However, in an alternative possibility, the divert position could be the datum position or, in a further alternative, the wheel 10 could be rotated or not depending upon the information about the next note. Thus, if the wheel 10 has just diverted a note and the next note also should be diverted, then the wheel can remain in its position but if the next note is to be stacked then the wheel will be moved to bring the slot 16 into alignment.

FIGS. 3A and 3B illustrate a second example of a stacking module according to the invention. In this case, a stacking wheel 30 is provided having just two banknote receiving slots 31,32. The wheel 30 has a main central body section 33 and a pair of outer tines 34,35, the slots 31,32 being defined between each outer tine and the main body portion. The main body portion 33 has two concave shaped outer surface parts 36,37.

A stacking position 17 is provided as in the FIG. 2 example. However, in this second example, the reject position 23′ is located below the banknote delivery position 20.

As in the previous example, the stacking wheel 33 is initially positioned at a datum position (FIG. 3A) in which one of the slots, in this case the slot 32, is in alignment with the banknote delivery position 20. A banknote can then be delivered into the slot 32, the wheel rotated anti-clockwise and the banknote stacked in the second position 17 as before.

When a banknote is to be diverted into the reject position 23′, the control system 5 operates the stepper motor 6 to rotate the stacking wheel a few degrees in an anti-clockwise direction (FIG. 3B) where it is held stationary so that the concave shaped part 36 faces the banknote delivery position 20. When a banknote exits from the note delivery position 20, it is diverted as a result of contact with the concave surface part 36 towards and into the reject stacking position 23′.

Once the note has been fully diverted into the reject position 23′, the control system 5 operates the stepper motor 6 to rotate the stacking wheel 30 a few degrees clockwise to bring the slot 32 back into alignment with the banknote delivery position 20.

In these examples, stacking positions 23 and 23′ are described as reject stacking positions. However, this should not imply that they have to receive only rejected notes. For example, rejected notes could be supplied to the stacking position 17 and acceptable notes to the stacking positions 23,23′. Furthermore, although stacking positions 23,23′ have been shown in these examples, the diverted notes could be fed to a further transport for delivery elsewhere.

FIG. 4 illustrates a further example of a stacking wheel 40 which is shaped so as effectively to be a combination of the examples of FIGS. 2 and 3. In this example, the stacking wheel 40 has a pair of slots 31,32 as in the FIG. 3 example defined between a main central body section 41 and a pair of outer tines 42,43 respectively. The main body portion 41 has two concave shaped outer parts 44,45.

In addition, the radially outer ends of the tines 42,43 also have concave shaped parts 45,46 which serve a similar function to the concave parts 22 of the FIG. 2 example.

This stacking wheel 40 thus enables documents to be diverted up or down depending upon the requirements of the particular apparatus within which the stacking wheel is used.

While concave shaped parts have been shown, other shapes could be used as appropriate.

1. A document stacking module comprising a rotatably mounted stacking wheel having at least one generally radially outwardly extending slot which can be aligned with a document delivery position so as to receive a document, the wheel being rotatable to a stacking position where the wheel cooperates with a stripper member to extract a document from the slot whereby the document is stacked at the stacking position; a motor for rotating the stacking wheel; and a control system for controlling operation of the motor characterised in that the outer surface of a first part of the stacking wheel is shaped so that, when said first part is presented to the document delivery position, the document fed through the document delivery position towards the stacking wheel engages the first shaped part of the outer surface of the stacking wheel and is diverted away from the stacking wheel in a first direction.

2. A module according to claim 1, wherein the first shaped part presents a concave shape to the document delivery position.

3. A module according to claim 1, wherein the stacking wheel comprises at least one tine defining a wall of the document receiving slot, a radially outwardly facing surface of the tine defining said first shaped part.

4. A module according to claim 1, further comprising a second shaped part so that, when said second part is presented to the document delivery position, the document fed through the document delivery position towards the stacking wheel engages the second shaped part of the outer surface of the stacking wheel and is diverted away from the stacking wheel in a second direction.

5. A module according to claim 4, wherein the second shaped part presents a concave shape to the document delivery position, and wherein the stacking wheel comprises at least one tine defining a wall of the document receiving slot, a radially outwardly facing surface of the tine defining said second shaped part.

6. A module according to claim 1, wherein the motor is a stepper motor.

7. A module according to claim 1, wherein said control system is adapted to control said motor to position said slot or said shaped outer surface part of the stacking wheel facing the document delivery position.

8. A module according to claim 1, further comprising a second stacking position or a reject position or a transport path located to receive documents diverted by the stacker wheel.

9. Document handling apparatus comprising a document transport along which documents are fed to a document delivery position; document sensing apparatus for sensing one or more characteristics of the documents fed by the document transport system; and a document stacking module comprising a rotatably mounted stacking wheel having at least one generally radially outwardly extending slot which can be aligned with a document delivery position so as to receive a document, the wheel being rotatable to a stacking position where the wheel cooperates with a stripper member to extract a document from the slot whereby the document is stacked at the stacking position; a motor for rotating the stacking wheel; and a control system for controlling operation of the motor characterised in that the outer surface of a first part of the stacking wheel is shaped so that, when said first part is presented to the document delivery position, the document fed through the document delivery position towards the stacking wheel engages the first shaped part of the outer surface of the stacking wheel and is diverted away from the stacking wheel in a first direction, the control system being adapted to control the motor so that either the document receiving slot or the shaped outer surface part is presented to the document delivery position depending on information received from the document sensing apparatus.

10. Apparatus according to claim 9, wherein the document sensing apparatus is adapted to sense whether of the documents are fed singly.

11. Apparatus according to claim 9, wherein the document sensing apparatus is adapted to sense one or more of the denomination and authenticity of a banknote.

12. A method of operating a document stacking module comprising a rotatably mounted stacking wheel having at least one generally radially outwardly extending slot which can be aligned with a document delivery position so as to receive a document, the wheel being rotatable to a stacking position where the wheel cooperates with a stripper member to extract a document from the slot whereby the document is stacked at the stacking position, the outer surface of a first part of the stacking wheel being shaped so that, when said first part is presented to the document delivery position, a document delivered towards the stacking wheel is diverted away from the stacking wheel, the method comprising selectively rotating the stacking wheel to present either the document receiving slot or the shaped outer surface first part of the stacking wheel to the document delivery position.

13. A method according to claim 12, further comprising feeding documents to the document delivery position, sensing one or more characteristics of each document that has been fed to the document delivery position, and selectively rotating the stacking wheel according to the said one or more characteristics.

14. A method according to claim 13, wherein if the sensed characteristic(s) satisfies one or more predetermined conditions, the stacking wheel is rotated to present a document receiving slot to the document delivery position, wherein after a document has been at least partially received in the document receiving slot, the stacking wheel is rotated so that the document is stacked at the stacking position.

15. A method according to claim 13, wherein if the sensed one or more characteristics of the document does not satisfy one or more predetermined conditions, the method comprises presenting the shaped outer surface part of the stacking wheel to the document delivery position, causing the document to engage and be diverted by the said shaped outer surface part to a reject position.

16. A method according to claim 12, further comprising, after each document has been stacked or diverted, rotating the stacking wheel to a datum position.

17. A method according to claim 12, wherein the documents are documents of value.

18. A method according to claim 17, wherein the documents comprise banknotes.

19. A method according to claim 13, wherein the characteristics comprise one or more of condition, denomination and authenticity.
